(19) United States
(12) Patent Application Publication
(10) Pub. No.: US 2011/0112910 A1
(43) Pub. Date: May 12, 2011

(54) METHOD AND SYSTEM OF CREDIT DEFERMENT IN A PRIVATE COMMUNICATIONS NETWORK

(76) Inventor: Derek Devries, San Francisco, CA (US)

(21) Appl. No.: 12/769,568

(22) Filed: Apr. 28, 2010

Related U.S. Application Data
(63) Continuation-in-part of application No. 12/551,970, filed on Sep. 1, 2009.
(60) Provisional application No. 61/271,958, filed on Jul. 30, 2009.
(60) Provisional application No. 61/271,958, filed on Jul. 30, 2009.

(51) Int. Cl. G06Q 30/00

(52) U.S. Cl. 705/14.69; 705/1.1

(57) ABSTRACT

Disclosed are a system, method, and article of manufacture for credit deferment in a private communications networking are disclosed. A media content in a digital format is generated. The media-content to a server that manages a website available only within the private computer network is uploaded if a provider of the content defers a specified number of credits to be acquired in the future to a manager of the website. Access to the media content is provided to a member user of the private computer network. The media content is made available for the member user via the website. A unit of credit to the website manager is allotted upon each viewing of the media content up to the specified number of credits. The unit of credit is allotted to the provider of the media content after the specified numbers of credits have been allotted to the website manager. A verification protocol is utilized to determine if the member user observes a specified portion of at least one of a media content and an advertisement associated with the media content before the credit is allotted. A transactional history of a content deferment agreement is provided to an entity operating on the private computer network.

### CLAIM OF PRIORITY

This application claims priority to U.S. Provisional Patent Application titled “MEDIA SYSTEM”, No. 61/271,958 filed Jul. 30, 2009, and is hereby incorporated by reference. Additionally, this application claims priority as a continuation-in-part of U.S. patent application titled “ALLOCATION OF DIGITAL MEDIA STORE CREDIT FOR PRESENTATION OF AN ADVERTISEMENT WITH A MEDIA PLAYER”, Ser. No. 12/551,970 filed on Oct. 1, 2009, and is hereby incorporated by reference. Application Ser. No. 12/551,970 also claims priority to provisional application 61/271,958.

### FIELD OF TECHNOLOGY

This disclosure relates generally to a computer networking, and, more particularly, to a system, a method and an article of manufacture of a method and system of credit deferment in a private communications networking.

### BACKGROUND

Advertisers pay providers of traditional media (e.g., television, radio and print media) to place or play an advertisement. The consumers of traditional media typically have no choice as when or how the advertisements are provided. For example, a television view typically watches advertisements temporally sequenced throughout a television program. The television program is not available through the television media without advertisement. This pattern holds true for the radio and print media as well. Recently, new devices (e.g. digital video recorders, mp3 players) and forms of media (e.g. video sharing websites, satellite radio) have become available that allow a consumer to filter out advertisement or provide media content without advertisements. Thus, advertisers can lose audience size and media content providers can lose advertisement revenue.

Additionally, the World Wide Web (WWW) has seen the rise of the phenomenon of the democratization of producing entertainment media. For example, a layperson can create a video and post the video on a video sharing website. The video can “go viral” and gain in popularity. However, the actions of the user and other data related to the popularity of the media content may not be available to other users of the system. Thus, other users can lack important information as to how to increase the popularity of media content they create.

### SUMMARY

A system, method, and article of manufacture for credit deferment in a private communications networking are disclosed. In one aspect, a private computer network provides access to media content to a member user. A content provider generates a media content in a digital format. A media-content website manager makes the media content available for the member user via a website available within the private computer network. The media-content website manager enables the content provider to upload the media-content to a website server managed by the media-content website manager if the content provider defers a specified number of credits to be acquired in the future to the media-content website manager. The credit is allotted to the media-content website manager upon each viewing of the media content up to the specified number of credits and wherein the credits are allotted to the content provider after the specified number of credits has been allotted to the media-content server manager.

In another aspect, a media content in a digital format is generated. The media-content to a server that manages a website available only within the private computer network is uploaded if a provider of the content defers a specified number of credits to be acquired in the future to a manager of the website. Access to the media content is provided to a member user of the private computer network. The media content is made available for the member user via the website. A unit of credit to the website manager is allotted upon each viewing of the media content up to the specified number of credits. The unit of credit is allotted to the provider of the media content after the specified numbers of credits have been allotted to the website manager. A verification protocol is utilized to determine if the member user observes a specified portion of at least one of a media content and an advertisement associated with the media content before the credit is allotted. A transactional history of a content deferment agreement is provided to an entity operating on the private computer network.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a block diagram showing a schematic view of an example private communications network for implementing one or more embodiments.

FIG. 2 is a block diagram showing an exemplary media-content website server in accordance with one or more embodiments.

FIG. 3 is a block diagram showing an exemplary media-system manager server in accordance with one or more embodiments.

FIG. 4A shows a flowchart of an illustrative process for credit deferment in a private communications networking in accordance with one embodiment.

FIG. 4B shows a continuation of the flowchart of the illustrative process for credit deferment in a private communications networking in accordance with one embodiment.

FIG. 5 shows a schematic view of an illustrative display screen according to one or more embodiments.

FIG. 6 is a block diagram showing an exemplary computing environment in which the technologies described herein can be implemented accordance with one or more embodiments.

Other features of the present embodiments will be apparent from the accompanying drawings and from the detailed description that follows.

### DETAILED DESCRIPTION

Disclosed are a system, method, and article of credit deferment in a private communications networking. Although the present embodiments have been described with reference to specific example embodiments, it will be evident that various modifications and changes can be made to these embodiments without departing from the broader spirit and scope of the various clahils.

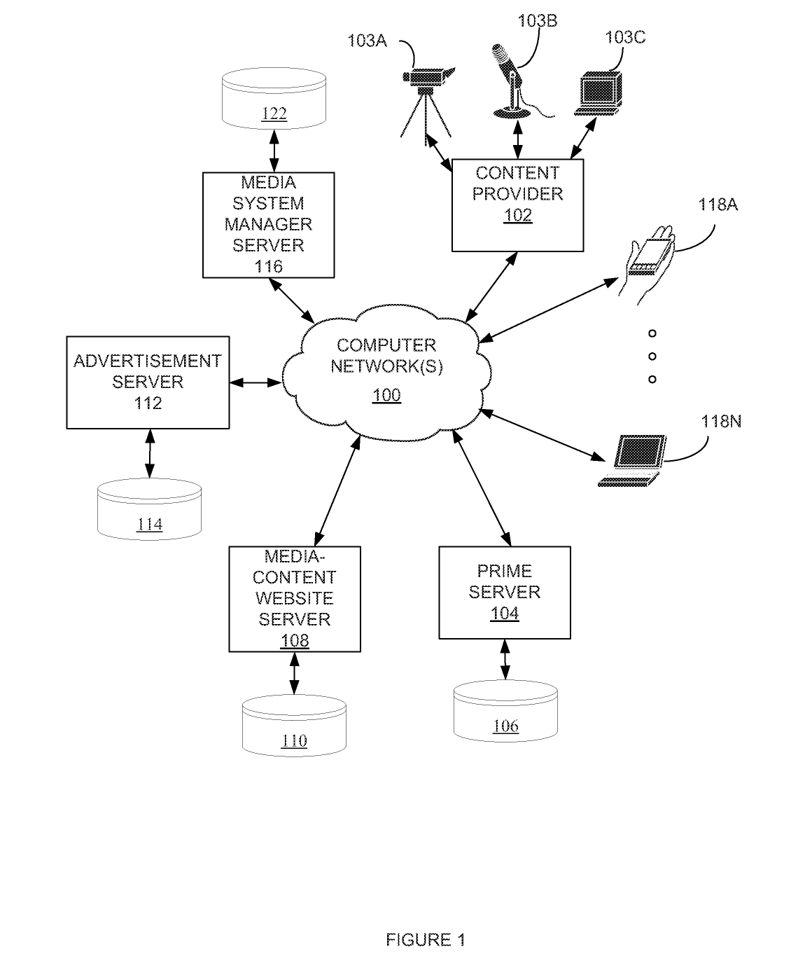

FIG. 1 is a block diagram showing a schematic view of an example private communications network for implementing one or embodiments. The devices of the private communications network communicate via the computer network(s) 100.

Computer network(s) 100 can include any suitable circuitry, device, system or combination of these (e.g., a wireless communications infrastructure including communications towers and telecommunications servers) operative to create a computer network. Computer network(s) 100 can provide wireless communications using any suitable short-range or long-range communications protocol. In some embodiments, computer network(s) 100 can support, for example, Wi-Fi (e.g., an 802.11 protocol), Bluetooth™, high frequency systems (e.g., 900 MHz, 2.4 30 GHz, and 5.6 GHz communication systems), infrared, other relatively localized wireless communication protocols, or any combination thereof.

In some embodiments, computer network(s) 100 can support protocols used by wireless and cellular phones and personal email devices (e.g., a smart phone). Such protocols can include, for example, GSM, GSM plus EDGE, CDMA, UMTS, quadband, and other cellular protocols. In another example, a long-range communications protocol can include Wi-Fi and protocols for placing or receiving calls using VOIP or LAN. Furthermore, in some embodiments, computer network(s) 100 can include an internet protocol (IP) based network such as the Internet. In this way, the devices of FIG. 1 can transfer data between each other as well as with other computing devices (e.g. third party servers and databases) not shown for the purposes of clarity.

Additionally, in some embodiments, the computer network(s) 100 can also include one or more local area networks (LAN) coupled to form a private wide area network (WAN). For example, a LAN can be implemented using Ethernet networking technology. The WAN can be a private network physically scaled to cover a geographic area sufficient to cover the private networks membership distribution. In some embodiments, the WAN may also be accessible via a secure website on the Internet. In some embodiments, a user may be required to create a user account and provide some user information before gaining access to the WAN. In other embodiments, a vetting proves can be implemented to determine user information has been truthfully provided before the user can access the WAN.

Generally, the content provider 102 can include both hardware and software applications to generate media content. Typical media content can include digital audio content (e.g. videos, movies, television shows, photographs) 103A, audio content (e.g. songs formatted in MP3 or other digital audio format) 103B and/or other digital entertainment media development with a computer (e.g. video games, e-books) 103C. Some embodiments of FIG. 1 can include multiple content providers 102. Typically, content provider 102 can communicate media content to another device of FIG. 1, such as the prime server 104 and the media-content website server 108, via computer network(s) 100.

Generally, prime server 104 can include both hardware and software applications to manage the aggregation and distribution of specialized media content provided by one or content providers 102. For example, the prime server 104 can aggregate videos of a particular genre. Prime server 104 can store aggregated media content in the database 106.

Content provider 102 and/or prime server 104 can upload media content to the media-content website server 108. In some embodiments, according to the rules of the private communications network of FIG. 1, a member user, such as member users 118A-N, can access media content stored in the private communications network through the media-content website server 108. Typically, a website includes a collection of related web pages, images, videos or other digital assets that are addressed relative to a common addressing form such as a Uniform Resource Locator (URL). The website can be secured (e.g. employ encryption, password to access) such that only members of the private communications network can access it. In addition to media content, in some embodiments, the media-content website server 108 can also enable access to advertisements provided by the advertisement server 112. Media content and advertisements can be stored in the database 110. Some embodiments of FIG. 1 can include more than one media-content website servers 108.

Generally, advertisement server 112 can include both hardware and software applications to provide advertisements accessible via the media-content website server 108. Typically, advertisements can be generated by third-party vendors. However, in some embodiments, prime server 104 and content provider 102 can also generate advertisements for their own respective media content. In some embodiments, access to the media-content website server 108 for both advertisements and media content can be purchased with credits. A more detailed explanation of the rules governing the credit system of the private communication network of FIG. 1 is provided infra (see the description of the media-system manager server 116). Advertisements can be stored in the database 114.

Generally, media-system manager server 116 can include both hardware and software applications to manage the behavior of entities in the private computer network. For example, the media-system manager server 116 can enforce the rules of the private computer network. The media system manager server 116 can control access to the private computer network by outside users (e.g. provide registration services, provide password applications that control access). The media-system manager server 116 can also manage the disbursement and remittance of credits by members of the private computer network. The media-system manager server 116 can provide verification protocols and applications that ensure that member users 118A-N observes a specified portion of the media content or an advertisement before the credit is allocated to at least one of the content provider, the media-content website manager and the prime-server manager. Furthermore, the media-system manager server 116 can enforce an agreement between the content provider 102 and the media-content website server 108. Media-system manager server 116 can ban a member for not abiding by a credit deferment agreement or other rule of the private communication network of FIG. 1.

Database 122 can be used to store information related to the functions of the media-system manager 116. For example, deferment agreement, credit data and/or registered member demographic information can be stored in database 122.

Generally, member users 118A-N include end users of the private communications system of FIG. 1. Membership is limited to users who have registered with an administrative entity that manages the media-system manager server 116. In some embodiments, the media system manager server 116 can charge a fee for membership privileges. Member users 118A-N can utilize any network enabled device such as a smart phone, a personal computer, a laptop and/or a tablet computer to access the media content hosted by the media-content website server 108. In some embodiments, member user 118A-N can also function as content providers 102, primer servers 104 and/or advertisement providers. A member user 118A-N can acquire credits for providing these functions. Additionally, in some embodiments, a member user 118A-N can also acquire credits by viewing media content and/or advertisements. It should be noted that any element shown in FIG. 1 can be extant as a plurality of elements. For example, in some embodiments, a plurality of media-content web site servers, a plurality of content providers, a plurality of advertisement servers and/or a plurality of media-system manager servers can be extant.

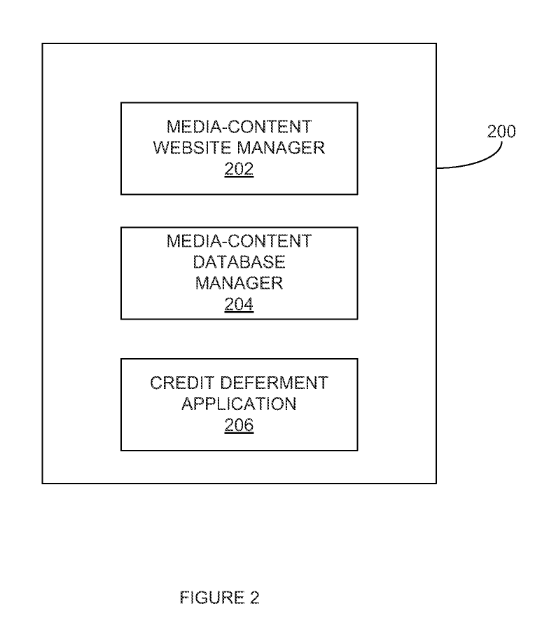

FIG. 2 is a block diagram showing an exemplary media-content website server in accordance with one or more embodiments. Media-content website server 200 includes a media-content website manager 202. In some embodiments, media-content website manager 202 can include functionalities for website administration and design. Media-content database manager 204 includes functionalities for administration of and access to the content of database 110. Credit deferment application 206 includes functionalities that allow a content provider to set up a credit deferment schedule. In some embodiments, credit deferment application 206 can provide a set of web pages that include, inter alia, credit deferments rates, agreement conditions and a means (such as an applet interface) of negotiating and finalizing a credit deferment agreement. It should be noted that other utilities, applications and devices of the media-content website server 200 have not been shown for the purposes of clarity.

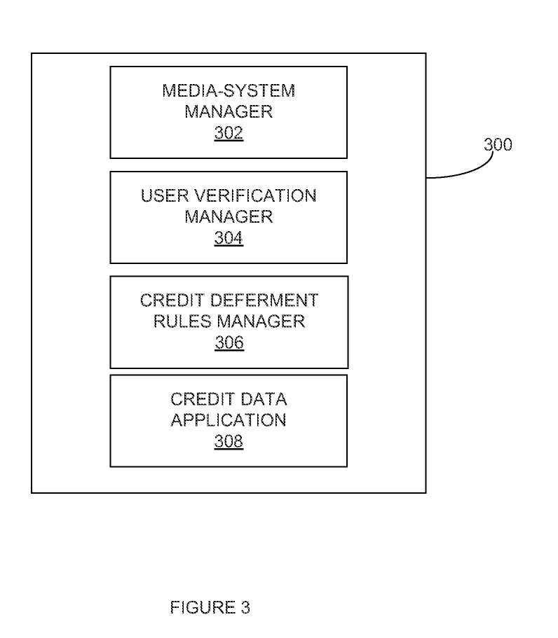

FIG. 3 is a block diagram showing an exemplary media-system manager server in accordance with one or more embodiments. In some embodiments, media-system manager server 300 can include a media-system manager 302. Media-system manager 302 can include functionalities that enforce the rules of the private communications network of FIG. 1. Media-system manager 302 can also provide a user interface for an administrator to input data and instructions regarding the operations of the private communications network as well. Media-system manager 302 can control which devices have access to the private communications network as well as the role each device is allowed to perform. For example, media-system manager 302 can provide permission for a content provider 102 to upload content to the media-content website server 108. In some embodiments, media-system manager 302 can provide instructions to the other modules of the media-system manager server 300.

User verification manager 304 can include functionalities that control access of member users to the private communications network of FIG. 1. In some embodiments, user verification manager 304 can manage authorization, authentication and accounting protocols to secure the private communications network. For example, user verification manager 304 can provide an access control list (ACL) to the various servers of the private communications network. The ACL can define what members users can do with a particular server's resources. User verification manager 304 can store a database of authorized member users, member-user passwords and their permitted actions in database 122.

Credit deferment rules manager 306 can include functionalities that allow members of the private communications network (e.g. a content provider) defer a specified number of credits to be acquired access to the services of another member. For example, the content provider 102 can defer a specified amount of potential credits to the media-content website manager 202. In exchange, the media-content website manager 202 can provide permission to the content provider to upload media content to the media-content website server 108.

The credit data application 308 records the amount of credit earned by each member of the private communications network of FIG. 1. This credit data can be stored in database 122. Additionally, credit data application 308 can manage the remittance of credits for privileges within the private communications network. An exemplary privilege can include access to the services of other devices such as access to another devices website audience, advertisements, media content and the like. In some embodiments, credits are earned by providing access to a device's and/or member's services. Credits can also be earned when a member user utilizes a service such as watching an advertisement and/or media content on a website hosted by the media-content website server 108. Additionally, credit data application 308 can store the data related to credit deferment agreements, earned credits, how credits are utilized by members, and the like. The credit data application 308 can store this data in database 122. A member of the private communications network can acquire this data from the credit data application 308. In this way, credit data can be utilized as a feedback mechanism whereby other members can imitate the patterns and actions followed by successful members. It should be noted that other utilities, applications and devices of the media-system manager server 300 have not been shown for the purposes of clarity.

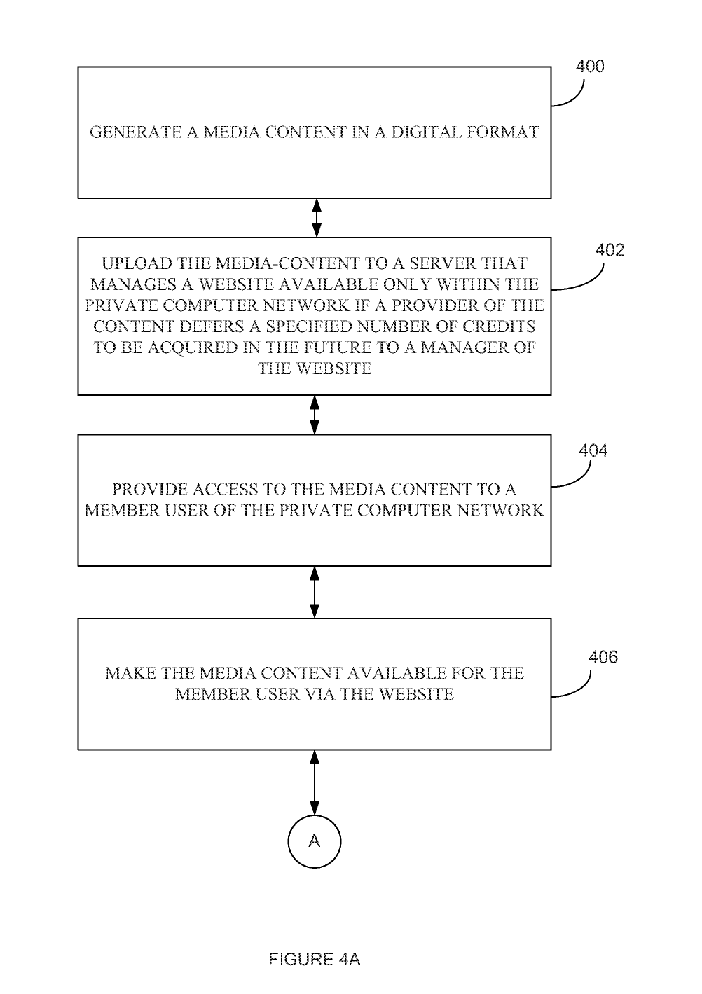

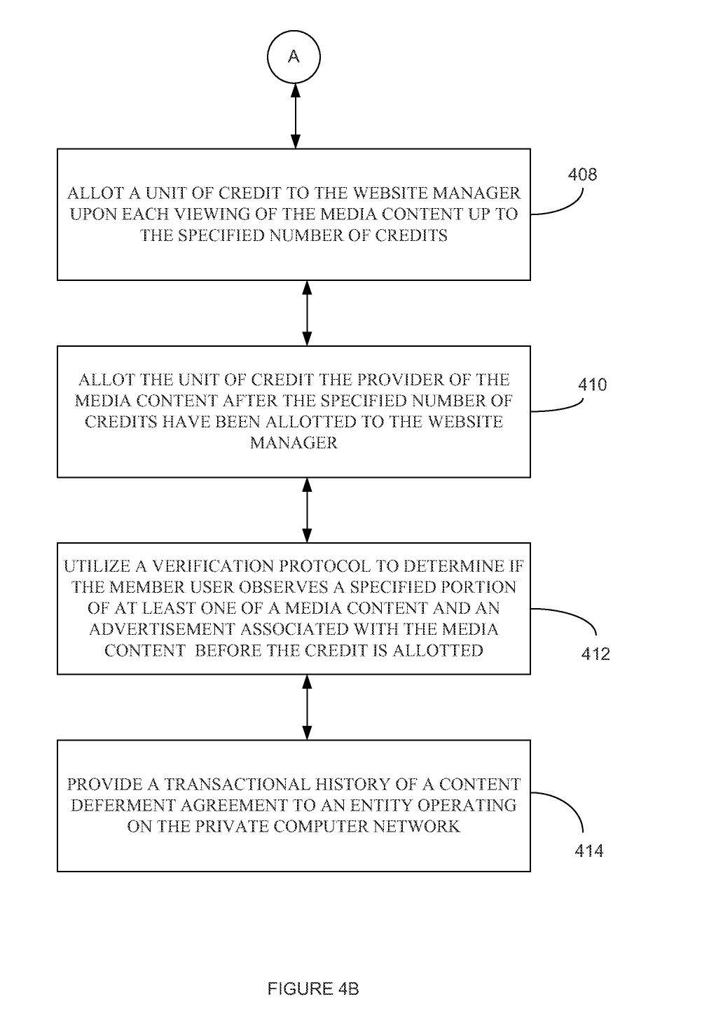

FIG. 4A shows a flowchart of an illustrative process for credit deferment in a private communications networking in accordance with one embodiment. Block 400 typically indicates generating a media content in a digital format. For example, content provider 102 can use video cameras, audio recording devices, computer-animation applications, and the like to generate digital media content. Content provider 102 can also utilize specialized media application to manipulate and edit the media content.

Block 402 typically indicates uploading the media-content to a server (e.g. media-content website server 108) that manages a website available only within the private computer network if a provider of the content defers a specified number of credits to be acquired in the future to a manager of the website. In some embodiments, multiple content providers can each contribute to a portion of the media content. Consequently, future earned credit can then be allotted to each content provider according to either a pre-arranged schedule and/or in proportion to the portion originally contributed. Additionally, in some embodiments, a content provider must provide a specified number of credits and/or arrange to defer that number of credits to a website in order to access the website. The amount of credits required can be dependent upon the popularity of the website as quantified by credits earning by viewers watching content. Additionally, in some embodiments, a website with a higher level of viewers can also access acquire greater revenue in the form of credits from the advertisement revenue. In this way, the quantity of viewers can provide an important feedback mechanism (along with access to credit data) within the system. This feedback mechanism can cause more popular media content to rise in viewer rates at a faster rate than unpopular media content and/or even popular media content in the absence of the feedback mechanism.

Block 404 typically indicates providing access to the media content to a member user of the private computer network. Block 406 typically indicates making the media content available for the member user via the website. Media-system manager 302 can manage access by a member user to the media content.

FIG. 4B shows a continuation of the flowchart of the illustrative process for credit deferment in a private communications networking in accordance with one embodiment. Block 408 typically indicates allotting a unit of credit to the website manager upon each viewing of the media content up to the specified number of credits. In some embodiments, credit data application 308 can record the allotting of credit. Block 410 typically indicates allotting to the unit of credit the provider of the media content after the specified number of credits have been allotted to the website manager. The amount of credit required to be deferred may be based on the popularity of the web site. In some embodiments, the deferment of credit can be delayed until a content provider initially earns a certain amount of credit. Upon reaching the certain amount of credits earned, a specified number of credits are then allotted to the media-content website manager. Credit deferment rules manager 306 can manage and provide the application resources to arranging for the deferment of credit.

Block 412 typically indicates utilizing a verification protocol to determine if the member user observes a specified portion of at least one of a media content and an advertisement associated with the media content before the credit is allotted. Block 414 typically indicates providing a transactional history of a content deferment agreement to an entity operating on the private computer network. Again, in some embodiments, credit data application 308 can record the allotting of credit.

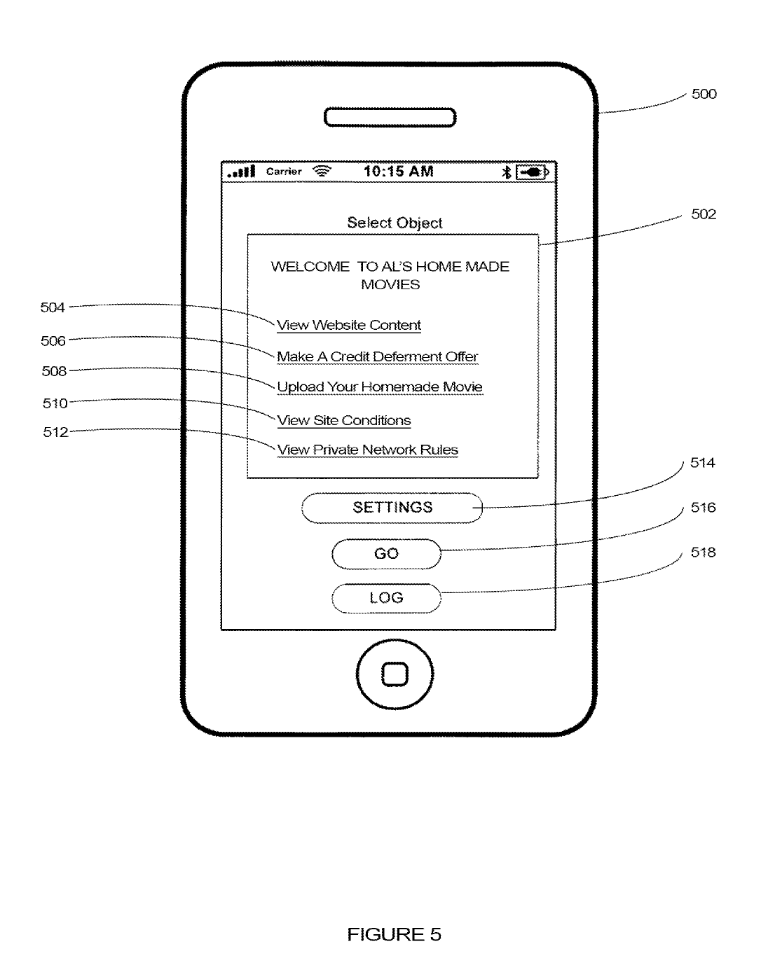

FIG. 5 shows a schematic view of an illustrative display screen according to one or more embodiments. Display 500 can include a website homepage 502. In some embodiments, website homepage 502 can include a set of messages with embedded hyperlinks 504-512. Embedded hyperlinks 504-512 may contain tables, images and other presentational devices referred to in the respective text of each hypertext. In some embodiments, embedded hyperlinks can be located in video and/or image elements of the website homepage 502. In some embodiments, embedded hyperlinks 504-512 can reference documents on the media-content website server 108, the advertisement server 112, the media-system management server 116, a third-party server outside the private communications network, and the like.

In some embodiments, display screen 500 can include several virtual buttons that allow a user to navigate the various web pages included in the private communications networks (as well as the Internet). For example, in some example embodiments, the “SETTINGS” virtual button 506 can cause the portable electronic device that renders display 500 to provide additional options to the user such as display configurations, media content access options, network navigation options, credit remittance options, access to the credit transaction history or statistics of a particular member or set of members of the private communications network, and the like. The “GO” virtual button can cause said portable electronic device to access a chosen navigation option. The “LOG” virtual button can be utilized to initiate an operation to store a credit recently earned for watching a particular media content and/or advertisement. For clarity, other possible virtual buttons and navigation tools have not been shown. However, it should be understood that display 500 can be configured to optimize access to the data available with the private communications network of FIG. 1.

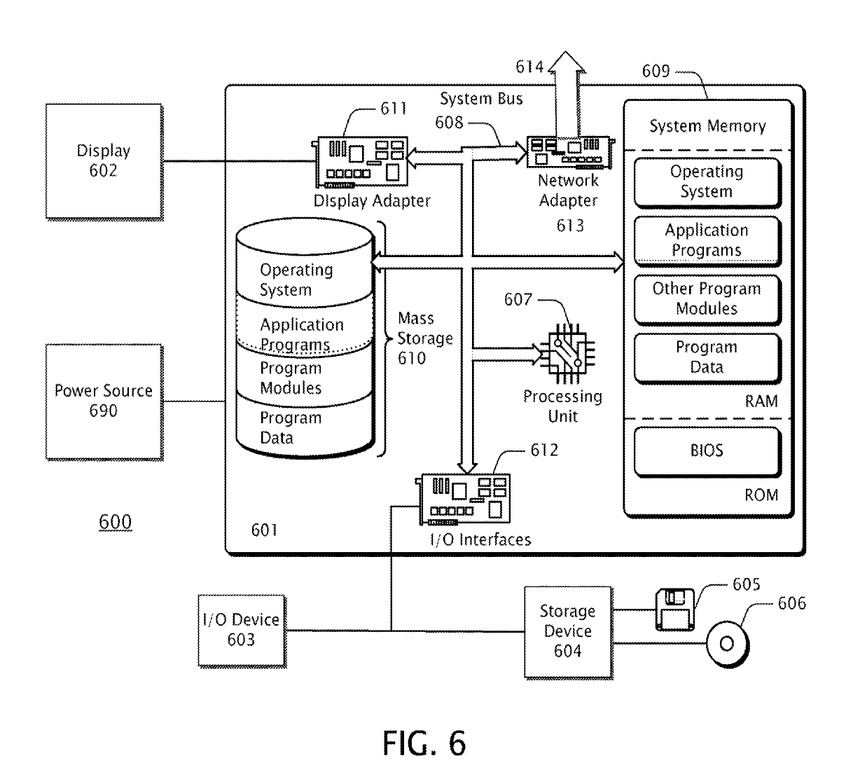

FIG. 6 is a block diagram showing an exemplary computing environment in which the technologies described herein can be implemented accordance with one or more embodiments. A suitable computing environment can be implemented with numerous general purpose or special purpose systems. Examples of well-known systems can include, but are not limited to, smart devices, microprocessor-based systems, multiprocessor systems, servers, workstations, and the like.

Computing environment 600 typically includes a general-purpose computing system in the form of a computing device 601 coupled to various components, such as peripheral devices 602, 603, 604 and the like. System 600 may couple to various other components, such as input devices 603, including voice recognition, touch pads, buttons, keyboards and/or pointing devices, such as a mouse or trackball, via one or more input/output (“I/O”) interfaces 612. The components of computing device 601 may include one or more processors (including central processing units (“CPU”), graphics processing units (“CPU”), microprocessors (“IJP”), and the like) 607, system memory 609, and a system bus 608 that typically couples the various components. Processor 607 typically processes or executes various computer-executable instructions to control the operation of computing device 601 and to communicate with other electronic and/or computing devices, systems or environment (not shown) via various communications connections such as a network connection 614 or the like. System bus 608 represents any number of several types of bus structures, including a memory bus or memory controller, a peripheral bus, a serial bus, an accelerated graphics port, a processor or local bus using any of a variety of bus architectures, and the like.

System memory 609 may include computer readable media in the form of volatile memory, such as random access memory (“RAM”), and/or nonvolatile memory, such as read only memory (“ROM”) or flash memory (“FLASH”). A basic input/output system (“BIOS”) may be stored in non-volatile or the like. System memory 609 typically stores data, computer-executable instructions and/or program modules comprising computer-executable instructions that are immediately accessible to and/or presently operated on by one or more of the processors 607.

Mass storage devices 604 and 610 may be coupled to computing device 601 or incorporated into computing device 601 via coupling to the system bus. Such mass storage devices 604 and 610 may include non-volatile RAM, a magnetic disk drive which reads from and/or writes to a removable, non-volatile magnetic disk (e.g., a “floppy disk”) 605, and/or an optical disk drive that reads from and/or writes to a non-volatile optical disk such as a CD ROM, DVD ROM 606. Alternatively, a mass storage device, such as hard disk 610, may include nonremovable storage medium. Other mass storage devices may include memory cards, memory sticks, tape storage devices, and the like.

Any number of computer programs, files, data structures, and the like may be stored in mass storage 610, other storage devices 604, 605, 606 and system memory 609 (typically limited by available space) including, by way of example and not limitation, operating systems, application programs, data files, directory structures, computer-executable instructions, and the like.

Output components or devices, such as display device 602, may be coupled to computing device 601, typically via an interface such as a display adapter 611. Output device 602 may be a liquid crystal display (“LCD”). Other example output devices may include printers, audio outputs, voice outputs, cathode ray tube (“CRT”) displays, tactile devices or other sensory output mechanisms, or the like. Output devices may enable computing device 601 to interact with human operators or other machines, systems, computing environments, or the like. A user may interface with computing environment 600 via any number of different I/O devices 603 such as a touch pad, buttons, keyboard, mouse, joystick, game pad, data port, and the like. These and other I/O devices may be coupled to processor 607 via I/O interfaces 612 which may be coupled to system bus 608, and/or may be coupled by other interfaces and bus structures, such as a parallel port, game port, universal serial bus (“USB”), fire wire, infrared (“IR”) port, and the like.

Computing device 601 may operate in a networked environment via communications connections to one or more remote computing devices through one or more cellular networks, wireless networks, LANs, WANs, storage area networks (“SAN”), the Internet, radio links, optical links and the like. Computing device 601 may be coupled to a network via network adapter 613 or the like, or, alternatively, via a modem, digital subscriber line (“DSL”) link, integrated services digital network (“ISDN”) link, Internet link, wireless link, or the like.

Communications connection 614, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Power source 690, such as a battery or a power supply, typically provides power for portions or all of computing environment 600. In the case of the computing environment 600 being a mobile device or portable device or the like, power source 690 may be a battery. Alternatively, in the case computing environment 600 is a desktop computer or server or the like, power source 690 may be a power supply designed to connect to an alternating current (“AC”) source, such as via a wall outlet.

Some mobile devices may not include many of the components described in connection with FIG. 6. For example, an electronic badge may be comprised of a coil of wire along with a simple processing unit 607 or the like, the coil configured to act as power source 690 when in proximity to a card reader device or the like. Such a coil may also be configure to act as an antenna coupled to the processing unit 607 or the like, the coil antenna capable of providing a form of communication between the electronic badge and the card reader device. Such communication may not involve networking, but may alternatively be general or special purpose communications via telemetry, point-to-point, RF, IR, audio, or other means. An electronic card may not include display 602, I/O device 603, or many of the other components described in connection with FIG. 6. Other mobile devices that may not include many of the components described in connection with FIG. 6, by way of example and not limitation, include electronic bracelets, electronic tags, implantable devices, and the like.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code, data, applications, programs, or the like maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium). Accordingly, the specification and drawings are to be regarded in an illustrative rather than a restrictive sense.

What is claimed is:

1. A computer-implemented system of a media-content website manager comprising:
a private computer network that provides access to media content to a member user;
a content provider of the private computer network generates a media content in a digital format; and
a media-content website manager of the private computer network makes the media content available for the member user via a website available within the private computer network, wherein the media-content website manager enables the content provider to upload the media-content to a website server managed by the media-content website manager if the content provider defers a specified number of credits to be acquired in the future to the media-content website manager, wherein the credit is allotted to the media-content website manager upon each viewing of the media content up to the specified number of credits and wherein the credits are allotted to the content provider after the specified number of credits have been allotted to the media-content server manager.

2. The computer-implemented system of claim 1 further providing a prime-server manager that aggregates a set of media content from a plurality of content providers.

3. The computer-implemented system of claim 2, wherein the media-content website manager enables the prime-server manager to upload the aggregated media-content to the media server if the prime-server manager defers the specified number of credits to the media-content server.

4. The computer-implemented system of claim 1, wherein the specified number of credits is algorithmically determined according to the popularity of the media-content provider.

5. The computer-implemented system of claim 4, wherein the popularity of the media-content provider is determined in part by a variable representing the total media contents views provided by the media-content website manager within a defined time period.

6. The computer-implemented system of claim 1 further comprising a media-system manager that controls access to the private computer network, that records acquired credits by an entity of the private computer network, and that enforces an agreement between the media-content provider and the media-content server manager.

7. The computer-implemented system of claim 7, wherein the media-system manager utilizes a verification protocol to ensure that the member user observes a specified portion of at least one of a media content and an advertisement associated with the media content before the credit is allocated to at least one of the content provider, the media-content website manager and the prime-server manager.

8. The computer-implemented system of claim 8, wherein the verification protocol comprises a challenge-response test that ensures a response to the challenge-response test is generated by a human.

9. The computer-implemented system of claim 1,
wherein the credit comprises a standard non-monetary unit of measurement whose value is determined by the media-system manager, and
wherein the credit can be redeemed with the media-content provider in exchange for the media-content website provider hosting at least one of a media-content and an advertisement on a website managed by the media-content website provider.

10. The computer-implemented system of claim 1, wherein the media-system manager makes credit redemption data available to the media-content provider, the media-content website manager, an advertisement provider and the prime-server manager.

11. The computer-implemented system of claim 1, wherein the media-system manager makes all transactional data describing any transaction or relationship between the media-content provider, the media-content website manager, an advertisement provider and the prime-server manager available to the media-content provider, the media-content website manager, an advertisement provider and a prime-server manager.

12. A computer-implemented method comprising:
generating a media content in a digital format;
uploading the media-content to a server that manages a website available only within the private computer network if a provider of the content defers a specified number of credits to be acquired in the future to a manager of the website;
providing access to the media content to a member user of the private computer network;
making the media content available for the member user via the website;
allotting a unit of credit to the website manager upon each viewing of the media content up to the specified number of credits;
allotting the unit of credit the provider of the media content after the specified number of credits have been allotted to the website manager;
utilizing a verification protocol to determine if the member user observes a specified portion of at least one of a media content and an advertisement associated with the media content before the credit is allotted; and
providing a transactional history of a content deferment agreement to an entity operating on the private computer network.

13. The computer-implemented method of claim 12, wherein the credit comprises a standard non-monetary unit of measurement whose value is determined by a manager of the private computer network.

14. The computer-implemented method of claim 12, wherein the private computer network comprises a wide area network.

15. The computer-implemented method of claim 12, wherein the credit enables a provider of the media content to purchase availability on the website.

16. The computer-implemented method of claim 12,
wherein a plurality of entities generate the media content, and
wherein each entity is allotted a partial unit of credit.

17. The computer-implemented method of claim 12, wherein the provider of the content defers a specified number of credits to the manager of the website after a certain amount of credit is earned by the provider.

18. The computer-implemented method of claim 12, wherein a machine is caused to perform the method of claim 1 when a set of instructions in a form of a machine-readable medium is executed by the machine.

19. A computer-implemented method of using the results of generating a media content in a digital format, uploading the media-content to a server that manages a website available only within a computer network if a provider of the content defers a specified number of credits to be acquired in the future to a manager of the website, providing access to the media content to a member user of the computer network, making the media content available for the member user via the website, allotting a unit of credit to the website manager upon each viewing of the media content up to the specified number of credits, allotting the unit of credit the provider of the media content after the specified number of credits have been allotted to the website manager comprising:
providing a transactional history of a content deferment agreement to an entity operating on the computer network.

20. The computer implemented method of claim 19 further comprising:
verifying whether the member user observes a specified portion of at least one of a media content and an advertisement associated with the media content before the credit is allotted.
